(19) United States
(12) Patent Application Publication
(10) Pub. No.: US 2017/0332875 A1
(43) Pub. Date: Nov. 23, 2017

(54) Grill Cleaning Tool

(71) Applicant: Michael Persichina, Rolling Hills Est., CA (US)

(72) Inventor: Michael Persichina, Rolling Hills Est., CA (US)

(21) Appl. No.: 15/157,419

(22) Filed: May 18, 2016

(51) Int. Cl. A47L 13/34; A47J 37/06

(52) U.S. Cl. CPC A47L 13/34; A47J 37/06

(57) ABSTRACT

A grill cleaning tool for scraping a grill having a plurality of spaced apart parallel rods is disclosed. The tool includes a scraper member attached to one end of an elongated handle at an approximate ninety degree angle such that when the tool is engaged to a grill rod, the plane of the scraper member is approximately perpendicular to the engaged grill rod while the elongated handle portion of the tool is disposed approximately parallel to the grill surface. The scrapper member includes at least one C-shaped grill receiving slot opening along one of its long edges, which is sized to receive at least one grill rod of a predetermined size. The grill cleaning tool is adapted to clean the entire surface of a grill rod by combining an intuitive longitudinally reciprocating motion along the grill surface and a simple pivoting of the tool about the grill rod.

### CROSS-REFERENCE TO RELATED APPLICATIONS

Not Applicable

### BACKGROUND OF THE INVENTION

### Field of Invention

This invention relates to a scraping tool for cleaning a grill surface with a plurality of spaced apart parallel grill rod members like those found on a barbeque.

### Background of the Invention

Similar tools are disclosed in U.S. Pat. Nos. 2,747,911, 3,820,185 and 4,958,403. U.S. Pat. No. 2,747,911 to Kuever (1954) discloses a scraping blade with a plurality of spaced apart U-shaped notches to engage the grill surface; however, since this tool engages multiple adjacent grill rods at the same time, it requires the notches to be uniformly oriented in its direction of opening and equally spaced apart in order to receive multiple rods simultaneously, thus never allowing for the scraping edge to ever reach the bottom side of the grill surface where the largest deposits of burnt food and encrusted grease often builds up.

Other scraping blades have been proposed that engage each grill rod individually in order to allow the scraping blade to move freely about the entire circumference of grill rods including the bottom surface. U.S. Pat. No. 3,820,185 to Phillips (1974) discloses a scraping blade with a single U-shaped opening that engages the topside of a grill rod. The blade must then be twisted to either side in order to pivot the cleaning slot around the grill so it may clean the under surface of the grill rod. However, this tool still lacks the ability to clean both the top and bottom surface of the grill rod with a single pass over the grill surface. Another example, U.S. Pat. No. 4,958,403 to Martin (1990) discloses a scraping blade with a T-shaped opening instead; however, the effort required to manipulate the scraping blade about each grill rod in an unnatural T-shaped motion pattern makes the grill cleaning process too cumbersome in practice.

### BACKGROUND OF THE INVENTION—OBJECTS AND ADVANTAGES

Accordingly, several objects and advantages of the present invention are:

(a) to provide a scraping blade with a C-shaped opening that can engage a grill rod from the side so that both the top and bottom surfaces of the grill rod may be cleaned with a single pass of the tool over the grill surface.

(b) to provide a scraping blade that with minimal rotation, orientates the C-shaped opening to engage the rest of the grill rod surface to be cleaned with a reciprocating longitudinal pass over the grill surface.

Further objects and advantages are to provide a scraping blade with a recess on the same side of the C-shaped opening which allows the blade to rotate further around the grill rod and thus situating the opening to engage the remaining untreated grill rod surface from the first pass of the tool in the center of the C-shape opening to provide maximum surface contact for a complete cleaning on the reciprocating return pass of the tool. Still further objects and advantages will become apparent from a consideration of the ensuing description and drawings.

### SUMMARY

The present invention provides for a grill cleaning tool for a grill having a plurality of parallel spaced apart grill rods. The tool includes a flat scraper member having a C-shaped opening along its long edge to engage a predetermined sized grill rod mounted to an elongated handle at an approximate right angle, thereby permitting the C-shaped opening to engage the top, side and bottom surfaces of the grill rod while the scraper member is approximately perpendicular to the grill rod and the elongated handle is disposed approximately parallel to the grill surface. The tool is adapted to clean the top and bottom surfaces of a grill rod with a single pass over the grill rod.

### DRAWINGS—FIGURES

FIG. 1 is a perspective view of the grill cleaning tool.

FIG. 2 is an end view of the grill cleaning tool detailing the interaction between the scraper member and the grill rod.

FIG. 3 is a fragmentary exploded perspective view detailing how the scraper member is attached to the elongated handle and its adaptability to accommodate different sizes of grill rods within the same scraper member.

### DRAWINGS—REFERENCE NUMERALS

| | |
|---|---|
| 10 grill cleaning tool | 11 grill rods |
| 20 scraper member | 21 C-shaped opening |
| 22 recess | 23 perpendicular fold |
| 24 notched scraper edge | 25 flat scraper edge |
| 26 mounting hole | 30 elongated handle |
| 31 receiving slot | 32 mounting screw |
| 33 mounting hole | 34 receiving nut |

### DETAILED DESCRIPTIONS

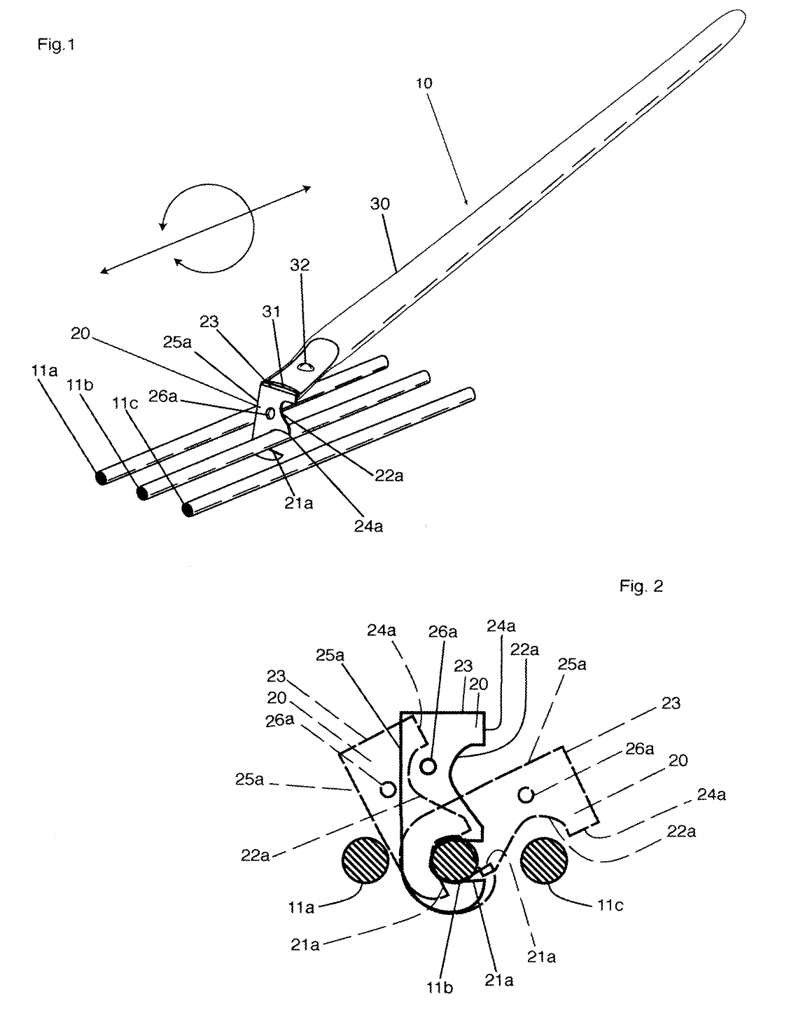

FIG. 1 is a perspective drawing of the grill cleaning tool 10 for cleaning a barbeque grill surface or the like with a multiple of spaced apart parallel grill rod members, three of which 11a, 11b and 11c are displayed. The tool consists of a scraper member 20 preferably metallic, attached to an elongated handle 30, which may be any length and may be adapted with a gripped handle portion.

The scraper member 20 has a C-shaped opening or receiving slot 21a and another elliptical shaped recess or clearance slot 22a along its notched edge 24a. The size of the C-shaped opening 21a may vary to accommodate the different sizes of grill rods 11 the scraper member 20 is intended to fit. The width of the scrapper member 20 from its flat or non-perforated edge 25a to its notched edge 24a and the shape and size of the clearance slot 22a can vary depending on the spacing between grill members 11 of the type of grill the scraper member 20 is designed to clean.

The scraper member 20 has an approximate ninety-degree angle bend 23 in it so that when the receiving slot 21a is engaged with the grill rod 11b, the elongated handle 30 of the grill cleaning tool 10 is disposed approximately parallel to the grill rod surface. The grill cleaning tool 10 is adapted to clean the entire surface of the grill rod 11b with a simple longitudinally reciprocating motion along the grill surface combined with a minimal pivoting motion about the grill rod 11b, as shown by the arrows in FIG. 1.

FIG. 2 is an end view of how the scraper member 20 can be twisted about the grill rod 11b to allow for the C-shaped opening 21a to engage all edges of the grill rod 11b. When the scraper member 20 is first engaged to the grill rod 11b, the C-shaped opening 21a is in contact with the top, left and bottom surfaces of the grill member 11b. This allows the scraper member 20 to effectively clean both the top and bottom surfaces of the grill rod 11b with a single pass of the grill cleaning tool 10 along the grill surface, which has generally been the limitation of previous grill scrapers. The scraper member 20 can then be pivoted around the grill rod 11b in a simple clockwise or counterclockwise motion to allow for the C-shaped opening 21a to clean the remaining surface of the grill rod 11b on the return pass of the grill cleaning tool 10.

The recess 22a allows for maximum clearance of the notched edge 24a of the scrapper member 20 from the adjacent grill rod 11c when a clockwise twisting motion is applied. The width of the scraping member 20 is minimized to allow for free space between its non-perforated edge 25a and the adjacent grill member 11a when the scraper member 20 is engaged to the grill rod 11b in the starting position and pivoted in a counterclockwise motion.

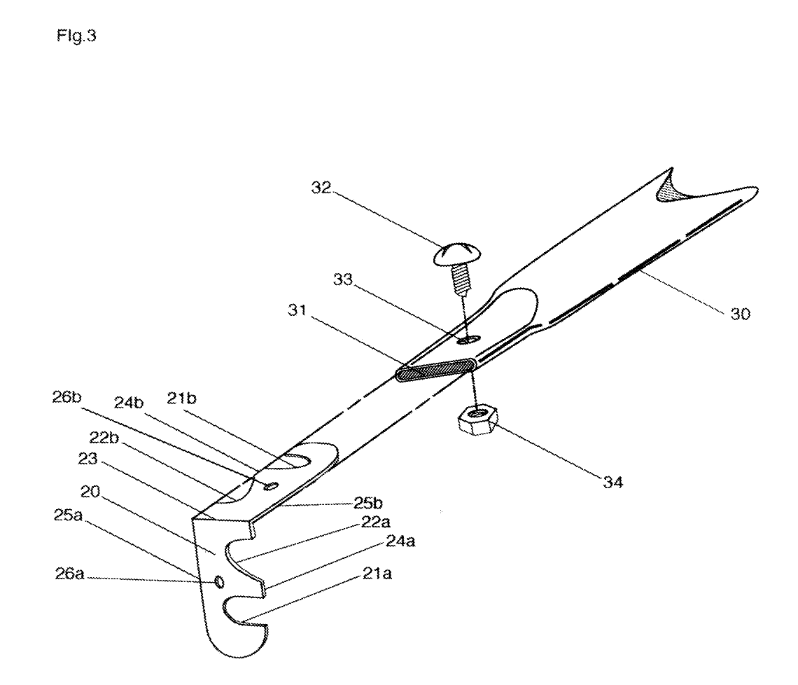

FIG. 3 is a fragmentary exploded perspective view of the scraper member 20 and its receiving slot 31 on the elongated handle portion 30 of the grill cleaning tool 10. The scraper member 20 is provided with another set of receiving 21b and clearance 22b slots oriented along the opposite end of the scraper member about the angular bend 23 to accommodate a different size grill rod. The openings 21b and 22b at the opposite end of the scraper member 20 is essentially identical to the openings 21a and 22b except that the C-shaped opening 21a and 21b are sized differently to receive a grill rod 11 of a different predetermined size.

The scraper member 20 also includes two mounting holes 26a and 26b, one for each size setting of the C-shaped opening, 21a and 21b respectively. In practice, after the size of the C-shaped opening, 21a or 21b has been matched to the grill rod 11 size in question, the opposite portion of the scraper member not in use will be inserted into the receiving slot 31 of the elongated handle 30 of the grill cleaning tool 10, leaving the selected half of the scraper member 20 exposed for grill contact. Once the scraper member 20 is inserted into the receiving slot 31, it is mounted in place with a mounting screw 32 threaded through a mounting hole 33 on the elongated handle 30 and the selected mounting hole, 26a or 26b on the scraper member 20 and finally grounded to a receiving nut or fastener 34.

Accordingly, the reader will see that the present invention provides for a grill cleaning tool that can clean both the top and bottom surfaces of a grill rod, where food deposits and grease encrustations are the greatest, with a single pass of the tool along the engaged grill rod. The problem of other grill cleaning tools requiring the incorporation of awkward motion patterns in order to manipulate the scraper member about the entire surface of the grill rod is solved with an adaptation of a simple rotational twist of the grill cleaning tool that effectively engages the scraper member to the entire surface of the grill rod.

The invention incorporates the use of metal for the scraper member, which allows the adaptation of a more streamlined shape and a smaller size without any degradation in strength. The resulting smaller scraping member allows for the maximum clearance between grill rods which facilitates initial positioning of the cleaning tool receiving slot around the grill member and provides the crucial space required to maneuver the tool about the engaged grill rod with an uncomplicated and effortless twisting and reciprocating scraping motion.

Although the description above contains many specificities, these should not be construed as limitations on the scope of the invention, but rather as an exemplification of one preferred embodiment thereof. Many other variations are possible. For example, the scraper member can be of a different shape or length, the recess on the scraper member can be of another shape or it can be oriented on the flat edge of the scraper member or the scraper member can have no recess at all, the scrapper member can be extended to such a length as to not require a separate elongated handle, etc.

Accordingly, the scope of the invention should be determined not by the embodiment illustrated, but by the appended claims and their legal equivalents.

We claim:

1. A grill cleaning tool for a grill having a plurality of parallel spaced apart grill rods, comprising:
(a) a flat scraper member having a C-shaped opening along a long edge of said scraper member to engage a predetermined sized grill rod
(b) an elongated handle mounted to said scraper at an approximate right angle, thereby permitting said C-shaped opening to engage the top, side and bottom surfaces of said grill rod while said scraper member is approximately perpendicular to said grill rod and said elongated handle is disposed approximately parallel to said grill rod, facilitating cleaning of said grill rod with a longitudinal reciprocating motion,
whereby the top and bottom surfaces of a grill rod can be cleaned with a single pass of the grill cleaning tool over the grill rod.

2. The tool as defined in claim 1 wherein said scraper member includes a second semicircular shaped recess along a long edge of said scraper member allowing said scraper member edge to have additional clearance with adjacent grill rods when said tool is engaged.

3. The tool as defined in claim 1 wherein said C-shaped opening of said scraper member is predetermined in size to receive an appropriately sized grill rod.

4. The tool as defined in claim 1 wherein said scraper member is made of metallic material.

5. The tool as defined in claim 1 wherein the plane of said scraper member is approximately perpendicular to the longitudinal axis of said elongated handle.
